(19) United States
(12) Patent Application Publication
(10) Pub. No.: US 2022/0197805 A1
(43) Pub. Date: Jun. 23, 2022

(54) PAGE FAULT MANAGEMENT TECHNOLOGIES

(71) Applicant: Intel Corporation, Santa Clara, CA (US)

(72) Inventors: Shaopeng HE, Shanghai (CN); Anjali Singhai JAIN, Portland, OR (US); Patrick MALONEY, Portland, OR (US); Yadong LI, Portland, OR (US); Chih-Jen CHANG, Union City, CA (US); Kun TIAN, Shanghai, 31 (CN); Yan ZHAO, Shanghai (CN); Rajesh M. SANKARAN, Portland, OR (US); Ashok RAJ, Portland, OR (US)

(21) Appl. No.: 17/479,954

(22) Filed: Sep. 20, 2021

(30) Foreign Application Priority Data
Aug. 17, 2021 (CN) PCT/CN2021/112910

(51) Int. Cl. G06F 12/0831; G06F 12/1009; G06F 9/455

(52) U.S. Cl. CPC G06F 12/0835; G06F 2009/45583; G06F 9/45558; G06F 12/1009

(57) ABSTRACT

Examples described herein relate to at least one processor and circuitry, when operational, to: in connection with a request from a device to copy data to a destination memory address: based on a page fault, copy the data to a backup page and after determination of a virtual-to-physical address translation, copy the data from the backup page to a destination page identified by the physical address. In some examples, the copy the data to a backup page is based on a page fault and an indication that a target buffer for the data is at or above a threshold level of fullness. In some examples, copying the data to a backup page includes: receive the physical address of the backup page from the device and copy data from the device to the backup page based on identification of the backup page.

### CROSS-REFERENCE TO RELATED APPLICATION

This application claims the benefit of priority to Patent Cooperation Treaty (PCT) Application No. PCT/CN2021/112910 filed Aug. 17, 2021. The entire content of that application is incorporated by reference.

### BACKGROUND

A network interface device (NID) copies received packets to host. When a virtual machine (VM) is to process the received packets, memory associated with VM is pinned and virtual-to-physical address translations take place to access the received packets. A page table mapping translates virtual addresses to physical addresses. However, if no translation is available or an invalid translation to physical address (e.g., no physical address is associated with virtual address) is present, a page table fault occurs. A page fault can trigger access to a kernel to obtain the translation. If a page fault occurs, packet processing can stall while waiting for the page fault to resolve. PCIe standard Page Request Service (PRS) can cause Ethernet packet drops for receive Network Page Faults (rNPFs).

In some scenarios, the rNPF packet drops affects Input-Output Memory Management Unit (IOMMU) page fault platform solutions such as platforms from NVIDIA Mellanox, Advanced RISC Machines (ARM), and Intel®. ARM IOMMU stall mode allows for an ARM IOMMU hardware to stall device direct memory access (DMA) read and write operations in response to a page fault, and resume DMA operations after that page fault is solved by an IOMMU driver. However, stalling DMA read and write operations can increase latency to completion of packet processing.

### BRIEF DESCRIPTION OF THE DRAWINGS

FIG. 1 depicts a system where first level translation is utilized.

FIGS. 2A and 2B depict example manners of a device copying data to a memory device.

FIG. 3 shows an example page request descriptor format with backup page information.

FIG. 4 depicts an example paging entry.

FIG. 5 depicts an example sequence after a page table entry (PTE) fault with first level translation.

FIG. 6 depicts a scenario including exception cases and how Page Request Descriptor (PRD) chain and paging lock are utilized.

FIG. 7 is a system diagram where second level translation is utilized.

FIG. 8 is a sequence diagram after a PTE fault with second level translation.

FIG. 9 depicts an example system with nested translation.

FIG. 10 is a sequence diagram after a PTE fault with nested translation and non-faultable virtual IOMMU (vIOMMU).

FIG. 11 depicts a sequence after a PTE fault with nested translation and faultable vIOMMU.

FIGS. 12A and 12B and 12C depict example processes.

FIG. 13 depicts a system.

### DETAILED DESCRIPTION

Some examples attempt to avoid or reduce packet drops arising from an IOMMU page fault, such as rNPF, PRS or ARM Stall mode. In connection with a page table fault or page table entry translation error arising from a data copy to a destination memory address, some examples allocate at least one backup page and copy the data to the allocated backup page (e.g., bounce buffer). Data can be stored in the backup page while waiting for page table entry resolution to identify a destination page associated with a virtual address for the data. In connection with occurrence of a page fault, some examples provide backup pages and/or a region in cache to store the data from a direct memory access (DMA) write. A backup page queue can be used by IOMMU hardware to allocate a backup page (or portions(s) thereof) for an incoming data packet subject to a page table entry translation error. The backup page can be included in a IOMMU page fault request to the IOMMU driver and the packet stored in the backup page can be copied or merged with the destination page allocated and prepared by an IOMMU page fault handler.

In some examples, for a page fault, the device could request a data copy with an untranslated virtual address to a cache and/or main memory, and an IOMMU or other device interface can direct the data to be copied to the backup page without notifying the device. After page table entry resolution to associate a destination page with the virtual address, the data can be copied from the backup page to the destination page. Some examples attempt to avoid or reduce packet drops in connection with page faults, and not require changes to device hardware and/or driver, although changes to device hardware and/or driver can be made. Translation faults can be handled by an IOMMU or device interface regardless of the device or data type that is copied to a memory and page fault handling can occur in the IOMMU instead of the device, although the device can handle page faults in some examples.

Intel® Virtualization Technology for Directed I/O v3.2 specification (2020) (VT-D 3.2), defines three types of translations, namely, (1) first-level, mostly used for host application and containers; (2) second-level used for virtual machine (VM) without virtual IOMMU (vIOMMU); and (3) Nested Translation for VM with vIOMMU. VT-D 3.2 specifies IOMMU page fault using PRS with Address Translation Service (ATS) for translated accesses from Peripheral Component Interconnect express (PCIe) connected devices and defines Page Request Descriptor (PRD) to report IOMMU page fault to IOMMU driver to handle. In some examples, information related to an IOMMU page fault event, descriptor lock, back-up page, and/or destination page can be attached to a Page Request Descriptor described in VT-D 3.2.

Some examples are used in connection with translation from Host Virtual Address (HVA) or I/O Virtual Address (IOVA) to Host Physical Address (HPA). In some cases, First-Level Translation refers to translation from HVA or IOVA to HPA. The IOMMU page fault may occur when a physical page is not present in Page Table Entry (PTE) or a page table entry is invalid, e.g., Page Directory Entry (PDE) is not valid. Some examples are used in connection with translation from Guest Physical Address (GPA) to Host Physical Address (HPA).

Some examples can be used in a data center built as a composite node with high-performance networking for distributed storage and distributed computing (e.g., artificial intelligence (AI) and big data). In some examples, the backup page and/or the destination page are located in a memory device that is located in a server that is also connected through a device interface to the network interface device. In some examples, the backup page and/or the destination page are located in a memory device that is located in a memory pool or different server than a server that is connected through a device interface to the network interface device.

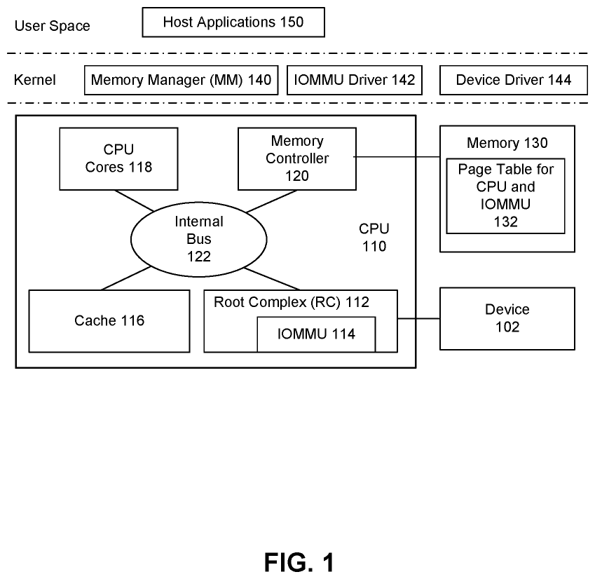

FIG. 1 depicts a system diagram that illustrates a system. To avoid or reduce packet-drop associated with receive Network Page Faults (rNPFs), various examples perform: device 102 writing a received packet associated with a translation fault to a backup page directly, determination of a destination page for a virtual address associated with the received packet, and copying the received packet stored in the backup page to the destination page. Device 102 can receive or access a descriptor with a virtual address and device 102 can request virtual address-to-physical address translation or use the virtual address directly as an untranslated read/write (e.g., in accordance with Peripheral Component Interconnect express (PCIe) or other public or proprietary specification). For example, an Address Type field in a protocol header of PCIe Specification version 5.0 can indicate whether an address is translated or not.

Device 102 can include a device connected to a platform using a device interface. Device 102 can be implemented as one or more of: a network interface controller (NIC), SmartNIC, router, switch, forwarding element, infrastructure processing unit (IPU), data processing unit (DPU), accelerator device (e.g., field programmable gate arrays (FPGA) or application specific integrated circuit (ASIC)), storage device, memory device, and so forth.

CPU 110 can include or utilize root complex 112, IOMMU 114, cache 116 (e.g., Level 1 (L1), Level 2 (L2), Level 3 (L3), and/or last level cache (LLC)), one or more CPU cores 118, and a memory controller 120. One or more CPU cores 118 can execute, in user space, an application 150 and/or application 150 using one or more microservices, as part of a virtual machine (VM), within a container, or other distributed or virtualized execution environment. One or more CPU cores 118 can execute, in kernel space, a memory manager (MM) 140, IOMMU driver 142, and device driver 144. IOMMU 114 can translate virtual addresses to physical addresses.

A device interface to provide communicative coupling between device 102 and root complex 112 can include one or more of: Peripheral Component Interconnect express (PCIe), Compute Express Link (CXL), a Double Data Rate (DDR) interface, and so forth. In some examples, root complex 112 can include IOMMU circuitry 114 that performs one or more of: providing access to a backup page in memory 130 or other memory device, and/or write packet subject to rNPF to a backup page directly. In some examples, IOMMU driver 142 can perform one or more: backup page management and/or IOMMU page fault handler to merge payload in the backup page to a destination page. A size of a page can be configured by an operating system (OS) and can be any size such as but not limited to multiples of 512 bytes, e.g., 4096 bytes, 8192 bytes, and so forth.

In some examples, a paging table can be shared by CPU 110 and IOMMU 114. In some examples, separate paging tables for CPU 110 and IOMMU 114 can be used. In such case, a Linux kernel can synchronize the IOMMU-In-Progress (IIP) status from IOMMU 114 to CPU 110 or vice versa in connection with synchronizing separate paging tables for CPU 110 and IOMMU 114. A flag in a virtual memory area (VMA) structure can be used to notify a CPU page fault process whether it to check IOMMU page table status before changing a CPU paging table.

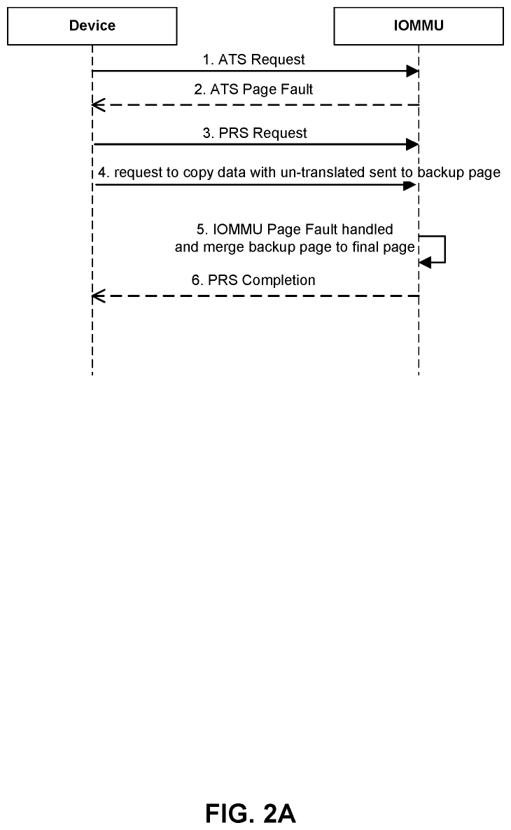

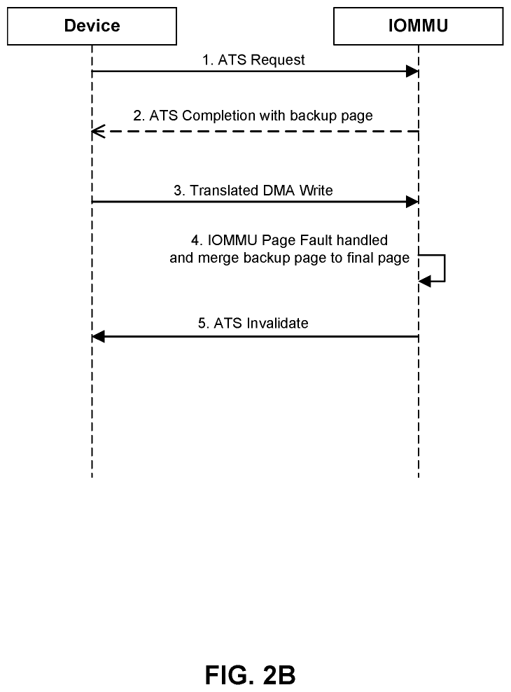

FIG. 2A depicts an example manner of a device copying data to a memory device. In some examples, the device can be connected to the memory using a device interface. The device can copy data to the memory device using a DMA engine. At (1), the device can issue an address translation request (e.g., PCIe Address Translation Services (ATS) request) to an IOMMU to provide a physical address translation of a virtual address. The device can attempt to store a packet data (e.g., one or more header fields and/or payload) in the memory device or cache. At (2), the IOMMU can indicate to the device that a virtual-to-physical address translation is not available in a page table or a virtual-to-physical address translation is invalid. The IOMMU can indicate a page fault to the device. The IOMMU can also indicate a page fault to the IOMMU driver. In some cases, the page table can be shared by a CPU and IOMMU.

At (3), the device can send a PCIe Page Request Service (PRS) to the IOMMU to request a memory page to associate with the virtual address. At (4), the device can provide data to the IOMMU with an un-translated virtual address to cause a copy of the data to a destination address. In response to receipt of a request to copy packet data associated with the un-translated virtual address, the IOMMU can access a descriptor indicative of an available backup page and copy the data associated with the un-translated virtual address to the available backup page. The IOMMU can cause the memory controller to copy the packet data to the backup page based on absence of a valid physical address translation for the virtual address. In some examples, the IOMMU can lock a page table entry (PTE) associated with the virtual address to prevent a device driver from accessing the PTE, and attempting processing of packet data.

In some cases, the use of the backup page can be based on a failure to translate the virtual address to a physical address. In some cases, use of the backup page can be based, additionally or alternatively, on the device determining packet dropping is likely based on a fullness of a packet buffer that stores received packets. At (5), an IOMMU can create a destination page for the virtual address and update the associated PTE for the virtual address. The IOMMU can copy the packet data stored in the backup page, based on its packet size (e.g., one or more header field and payload) and offset, into a corresponding memory address region in the destination page. An IOMMU driver (not shown) can create a destination page for the virtual address and update the PTE to indicate a mapping of the virtual address to a physical memory address associated with the destination page. The IOMMU driver can inform the device that the physical page is available. The backup page can be returned to a backup page pool after the packet is copied to the destination page. After updating of the PTE, the PTE can be unlocked and available for access by the device driver.

At (6), after association of the virtual address with a physical page and corresponding address in a PTE, the IOMMU can indicate to the device that PRS is completed. Subsequently, if the device issues a request for a virtual-to-physical address translation for the virtual address, the IOMMU can provide the translated physical address of the destination page.

FIG. 2B depicts an example where a backup page is used to store a received packet based on a write page fault. At (1), the device can issue an address translation request (e.g., PCIe Address Translation Services (ATS) request) to the IOMMU to provide a physical address translation of a virtual address. The device can attempt to store packet data (e.g., one or more header fields and/or payload) to a memory device or cache. At (2), the IOMMU can determine that a valid virtual-to-physical address translation is not available in a page table and provide a physical address of a backup page to the device. The IOMMU can communicate to the device that no page fault has occurred and provides the backup page physical address as translation. However, the IOMMU can indicate a page fault to the IOMMU driver. In some cases, the page table can be shared by CPU and IOMMU.

At (3), the device can issue a request to the IOMMU to copy packet data to the provided physical address translation. In some examples, the IOMMU can lock a page table entry (PTE) associated with the virtual address to prevent a device driver from accessing the PTE, and attempting to process packet data. At (4), the IOMMU can create a destination page for the virtual address and update the associated PTE to indicate the destination page physical address as a translation for the virtual address. The IOMMU can copy the packet data stored in the backup page, based on its packet size (e.g., one or more header field and payload) and offset, into a corresponding memory address region in the destination page. An IOMMU driver (not shown) can create a destination page for the virtual address and update the PTE to indicate a mapping of the virtual address to the destination page. The IOMMU driver can inform the device that the physical page is available. The backup page can be returned to a backup page pool after the packet is copied to the destination page. After updating of the PTE, the PTE can be unlocked and available for access by the device driver.

At (5), after the PTE for the virtual address provided at (1) is updated, the IOMMU can communicate to the device that the previously used physical address translation for the virtual address is invalid so that for a subsequent copy or access of the virtual address, the device is to request another ATS.

A physical memory region can be allocated for a backup page and addresses in the physical memory region could begin with a prefix. This way, the IOMMU could identify a backup page address rapidly in untranslated DMA accesses. The IOMMU could locate the original fault paging entry from an address array index by a number from 0 for first backup up page, 1 for second etc. As this backup page can be a temporary storage, the performance could be further improved by leveraging special cache (e.g., LLC) functions. This backup page copies to another cache, and does not need to write-back to main memory, so one LLC instruction could be utilized for this copy operation, such as a CLMOVE to copy a cache line from the backup page to the destination page.

Some hardware security CPU features isolate VMs from the virtual-machine manager (VMM)/hypervisor and other non-trust domain (TD) software on a platform to protect TDs from a broad range of software. To avoid security risk of breaking the trust domain, the following actions could be applied: setup VM direct memory access (DMA) memory region in certain security zone, e.g., shared zone, and the VM could access the data in the shared zone with more caution (e.g., decrypting the data after reading or encrypting the data prior to copying the data); and establish security protocol for both CPU and device to follow to write or read from the shared zone so that the encrypted DMA content could be accessed and moved/merged by IOMMU driver but cannot be decrypted by the IOMMU driver.

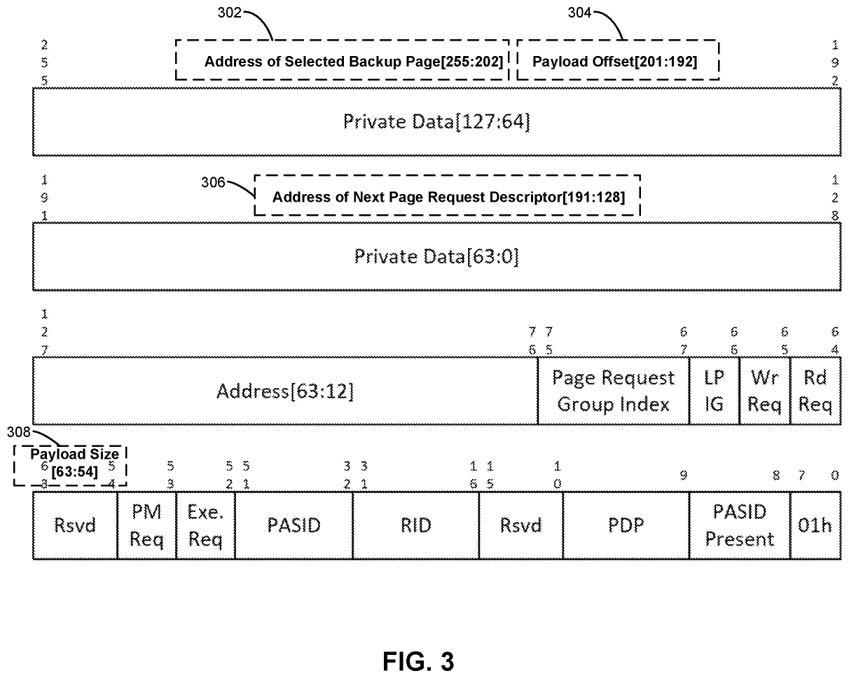

FIG. 3 shows an example page request descriptor format with backup page information. A page request descriptor (PRD) can report a IOMMU page fault to the IOMMU driver to address. The page request descriptor can be accessed by an IOMMU driver to identify an available page that can be used as a backup page in an event of an invalid or unavailable virtual-to-physical address translation. Field Address of Selection Backup Page 302 can indicate an address of a backup page in memory or cache. Field Payload Offset 304 can include an offset into the backup page at which a portion of a packet is stored (e.g., header, one or more header fields, and/or payload). Field Payload Size 308 can indicate a size of a packet. Fields 302, 304, and 308 can be used to identify the backup page memory address and a position of the packet in the backup page and can be used to copy the packet to a destination page after a translation of virtual-to-physical address is available. Field Address of Next Page Request Descriptor 306 can identify a chain of descriptors for multiple page faults on same a paging entry. For example, an IOMMU can provide the descriptor to an IOMMU driver to process and update with information in fields 302-308. In some examples, the page request descriptor is used for IOMMU-In-Progress (IIP) Mode and can be consistent with the VT-D 3.2 Specification. Bit positions among bits 255 to 0 are examples and any sizes of descriptor and descriptor fields can be used.

In some cases, a race scenario arises between a device driver accessing a page subject to a translation fault, and the IOMMU driver solving that fault by associating a page with a virtual address that is subject to a translation fault. In some examples, an IOMMU driver provides a page table entry (PTE) for the virtual address that is subject to a translation fault. If the device driver attempts to access the PTE to process data in an associated buffer, the device driver can access incorrect data and result in an error state. By use of a lock, resolution of the translation fault for the PTE can occur before the device driver can access the PTE and the device driver cannot access data until the lock is released.

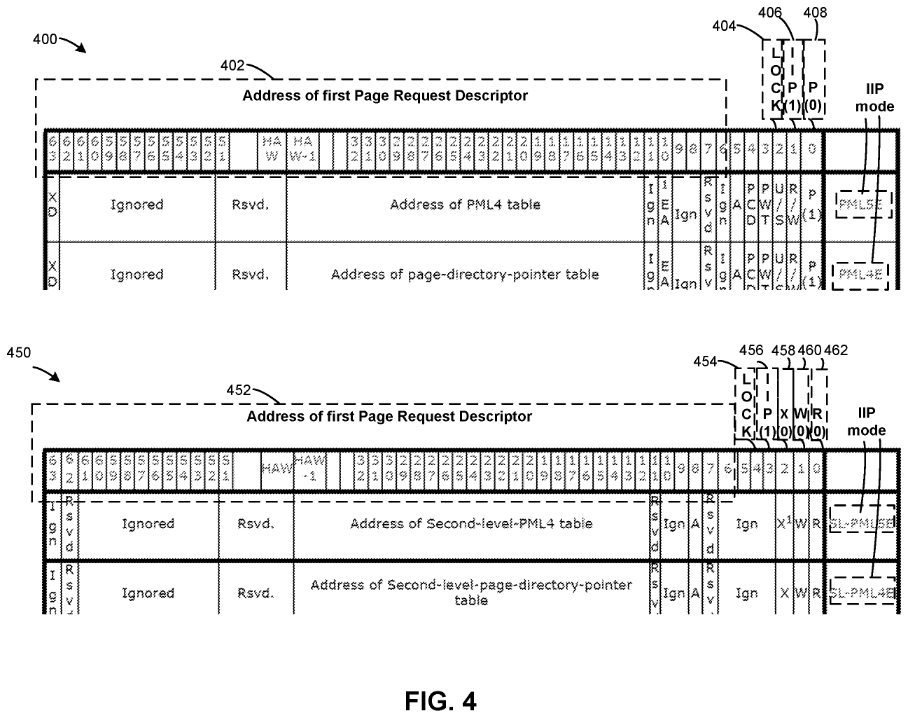

FIG. 4 depicts an example paging entry. The paging entry can be accessed by an IOMMU driver or device driver to identify a location of a page request descriptor and also determine whether the page request descriptor is locked or unlocked. Format 400 can be used at least in connection with translation from Host Virtual Address (HVA) or I/O Virtual Address (IOVA) to Host Physical Address (HPA). Address of first page request descriptor (PRD) 402 can identify a memory address in which a page request descriptor is stored. Lock 404 can indicate whether the page table entry is locked or unlocked. IOMMU-In-Progress (IIP) mode 406 can indicate a halfway paging entry state from non-present state to present state and reuse previously undefined fields of non-present.

IIP mode 406 can represent a transitional state in which an IOMMU and IOMMU driver are working to transfer this entry from “not-Present” mode to “Present” mode. P(0) 408 can indicate whether a current paging entry is present or not present. A paging entry can be present if the entry has a valid address from bits 12 to (HAW-1).

Format 450 can be used at least in connection with translation from translation from Guest Physical Address (GPA) to Host Physical Address (HPA). Address of first page request descriptor (PRD) 452 can identify a memory address in which a page request descriptor is stored. Lock 454 can indicate whether the page table entry is locked or unlocked. IOMMU-In-Progress (IIP) mode 456 can indicate a halfway paging entry state from non-present state to present state and reuse previously undefined fields of non-present. If X(executable), W(Writable) and R(Read-able) are all 0 values, it can have the same indication as P(0)=0 and can indicate that a current paging entry is not present.

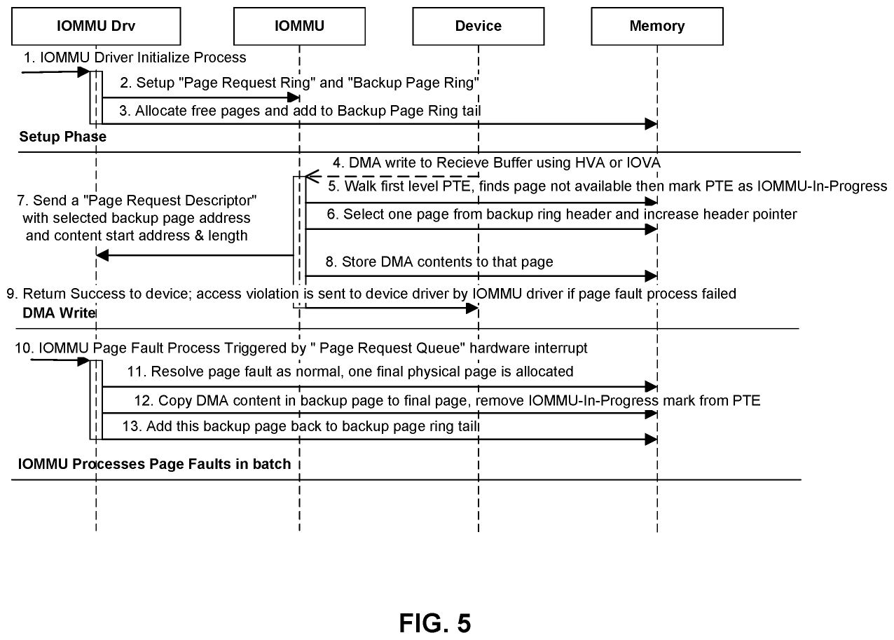

FIG. 5 depicts an example sequence after a PTE fault. At (1), IOMMU driver (Drv) can initialize a process to respond to a failure to translate a virtual address to a physical address. At (2), the IOMMU driver can setup a Page Request Ring and Backup Page Ring that identify available pages and available backup pages. At (3), the IOMMU driver can allocate free pages and add a free page to a tail of the Backup Page Ring. At (4), the device can copy, by DMA, packet data (e.g., one or more header fields and/or payload) to a Receive Buffer and identify a virtual address (e.g., HVA or IOVA) to the IOMMU. At (5), after walking the first level PTE, the IOMMU can determine a page is not available and mark a PTE for the virtual address as IOMMU-In-Progress (IIP).

At (6), the IOMMU can select a page from the Backup Ring head and increase the head pointer for the Backup Ring. At (7), the IOMMU can send a Page Request Descriptor (PRD) with selected backup page address and content start address and length of the packet data to the IOMMU driver. At (8), the IOMMU can cause the packet data to be stored in the backup page. In some examples, the backup page can be in a memory or cache. At (9), the IOMMU can Return Success to the device or an access violation is sent to device driver by IOMMU driver if page fault process failed.

At (10), the IOMMU driver can trigger an IOMMU Page Fault Process a Page Request by a queue hardware interrupt. At (11), the IOMMU driver can indicate the page fault is resolved and a destination physical page is allocated for the virtual address. At (12), the IOMMU driver can cause a copy of the packet data stored in the backup page to the destination page for the virtual address and remove IOMMU-In-Progress indicator from the PTE for the virtual address. The packet data can be stored in the destination page identified in the PTE for the virtual address. At (13), the backup page used for the packet data can be added to a back of the backup page ring tail. In some cases, the device driver in kernel space can access the destination page after the page fault was handled by the IOMMU driver, so it will not recognize such a fault happened.

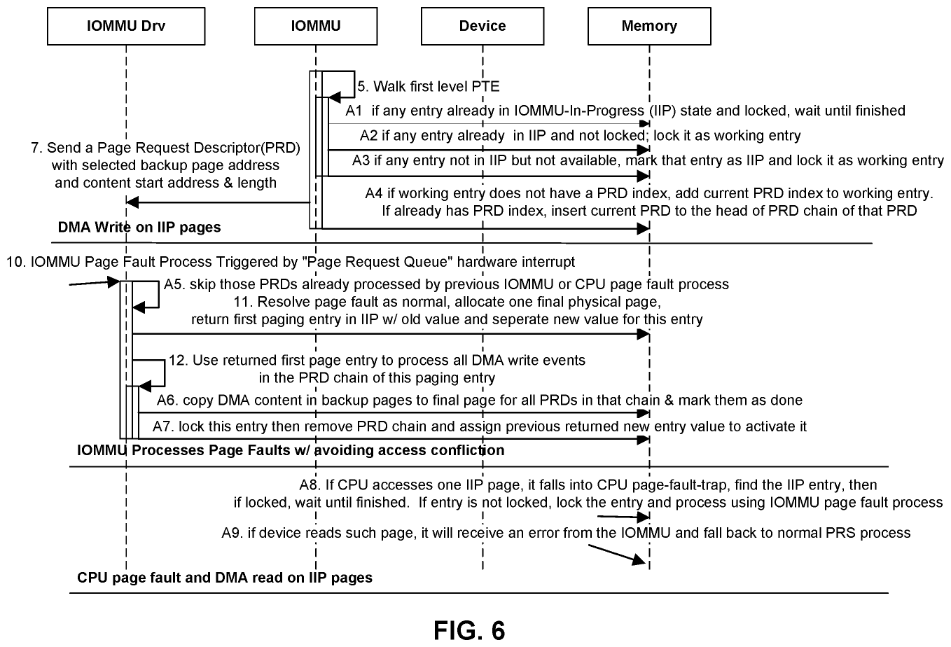

FIG. 6 depicts a scenario including four exception cases in which PRD chain and paging lock are utilized. The four exception cases can include: IOMMU page fault occurring on other paging entries than final PTE, device writes to an IIP page again, CPU accesses an IIP page, and DMA reads an IIP page.

Operations A1 to A4 are an example implementation of entry lock, PRD for other paging entries, and multiple PRD for same entry. In response to page fault occurring on other paging entries than a final PTE, a PRD chain can be assigned to that paging entry for all page faults under that paging entry. The IOMMU driver can handle page faults under that intermediate paging entry or only one final page fault at a time and move other page faults sharing a same intermediate paging entry to lower hierarchy paging entries.

DMA reads on an IIP page could be treated as a normal page fault in PRS or ARM stall mode as no packet may be dropped. In response to device writing to an IIP page again, a new PRD with new backup page can be allocated for each new DMA write and chained using “Address of Next PRD.” In some cases, one backup page or even one PRD could be used if the page faults happened on PTE rather than other paging entry. In some cases, the header PRD could have a point to buffer to information of all page faults rather than one PRD for each fault. At A5, PRDs already processed by the IOMMU or CPU page fault process could be skipped. At A6, content can be copied from one or more backup pages to a destination page for all PRDs in that chain and marked as completed. At A7, an entry can be located and removed from the PRD chain and assigned previous returned new entry value to activate the entry.

In response to the CPU accessing an IIP page, a lock bit in paging entry can be set to avoid access of the paging entry by CPU and IOMMU hardware. If the lock is set, IOMMU driver or hardware is processing this fault, and the CPU can wait until fault processing is finished. If not locked, the IOMMU driver can lock and process this IOMMU page fault inside the CPU page fault trap. At A8, if the CPU accesses an IIP page, a page fault trap occurs and an IIP page entry is identified. If the IIP entry is locked, CPU can wait until the page is unlocked. If the entry is unlocked, the entry can be locked and processed as an IOMMU page fault process. At A9, if the device reads the IIP page, an error (e.g., PCIe error) can be received from the IOMMU and a PRS process can be applied.

Second-level translation can be performed for a VM without vIOMMU using one level of translation from Guest Physical Address (GPA) to Host Physical Address (HPA). Guest Virtual Address (GVA) to GPA can occur in CPU MMU translation but not in an IOMMU translation. A Virtual Machine Monitor/Manager (VMM) can setup this second-level translation paging table while building a VM running memory mapping. If the host system does not support IOMMU page fault, VMM can pin guest physical memory to host physical memory before the VM is started if DMA copy operation is needed for this VM and Cloud Service Provider (CSP) does not over provision their hardware memory resources.

If a host system supports an IOMMU page fault, memory pinning may not be used. Physical memory could be allocated in the IOMMU page fault process when DMA operations use these memories. The IOMMU page fault may happen because a destination physical page is not present in Second-Level Page Table Entry (SL-PTE) or a paging table entry is invalid, e.g., Second-Level Page Directory Entry (SL-PDE) is not valid.

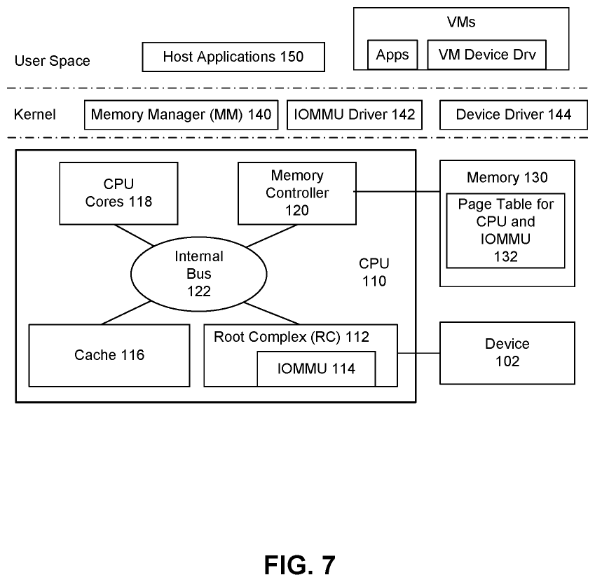

For nested translation with non-faultable vIOMMU, different Process Address Space Identifiers (PASIDs) can be allocated for different application or different I/O memory space for each I/O device, to provide secure isolation. FIG. 7 is a system diagram where second level translation is utilized. The system of FIG. 7 can include the components of the system of FIG. 1 and include user space VM with applications and device driver.

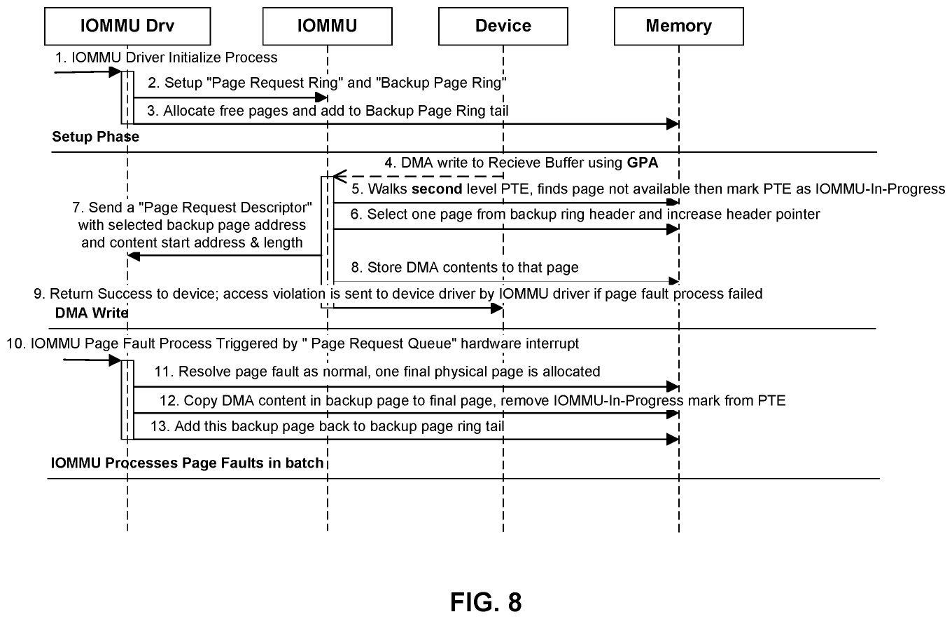

FIG. 8 is a sequence diagram after a PTE fault. The sequence can be similar to that of the sequence of FIG. 5, except for (4) including a copy of packet data to an address based on a GPA and at (5), after walking the second level PTE, the IOMMU can determine a page is not available and mark PTE for the virtual address as IOMMU-In-Progress.

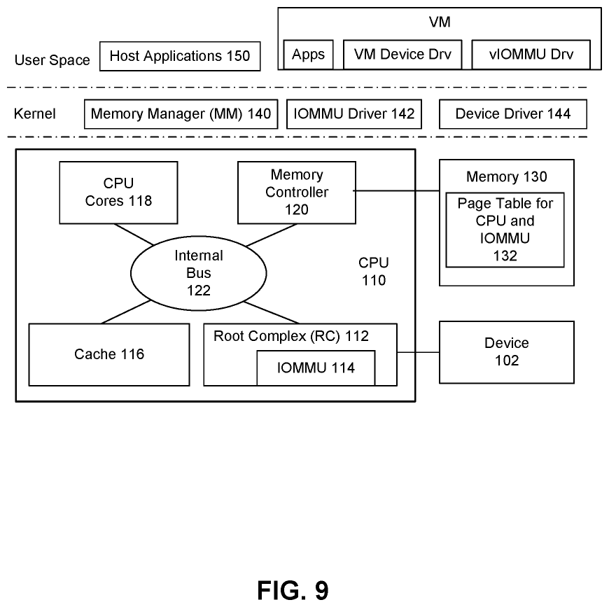

FIG. 9 depicts an example system with nested translation. The system of FIG. 9 can be used for nested translation with faultable vIOMMU, which does not need to pin DMA memory for a VM. Compared to the nested translation with non-faultable vIOMMU, this configuration includes a vIOMMU supporting IOMMU page fault event and vIOMMU emulation and driver provide features of IOMMU in system of FIG. 1 for the first level case. The system of FIG. 9 can include the components of the system of FIG. 1 and include a user space VM with applications, device driver (Drv), and vIOMMU driver. Compared to the configuration of FIG. 7, this configuration can include a vIOMMU emulation in a VMM and a vIOMMU driver executing in a VM; device 102 can provide a GVA or gIOVA to have security inside a VM rather than applications and different device drivers using a same GPA for a VM; and PRE not enabled for first-level translation inside the VM causes a page fault to occur in second-level paging entry.

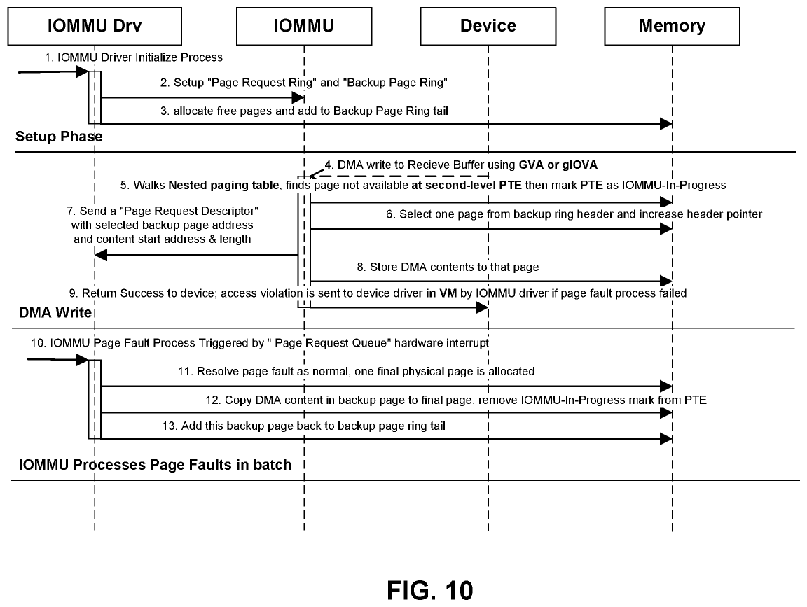

FIG. 10 is a sequence diagram after a PTE fault. The sequence can be similar to that of the sequence of FIG. 8, except for (4) including a copy of packet data to an address based on a GVA or gIOVA; at (5), after walking the nested paging table, the IOMMU can determine a page is not available at a second-level PTE and marks PTE for the virtual address as IOMMU-In-Progress; and at (9) an access violation is sent to a device driver in the VM by the IOMMU driver if page fault process failed.

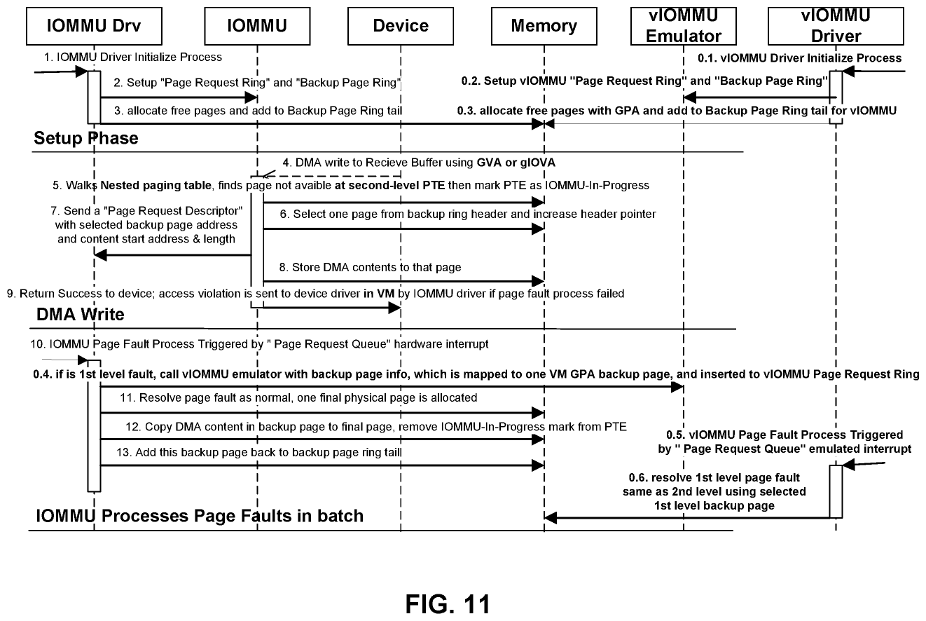

FIG. 11 depicts a sequence after a PTE fault. Compared to the sequence of FIG. 5, modifications include: at (5), walking nested paging table to find page is not available at a second-level PTE; at (9), the IOMMU can Return Success to the device driver in VM if page fault process failed. In addition, operations 0.1, 0.2, and 0.3 are added for vIOMMU driver and operations 0.4, 0.5, and 0.6 are added for first level fault case which are injected to vIOMMU emulation then handled by vIOMMU driver in a VM similar to that of a IOMMU page fault in host.

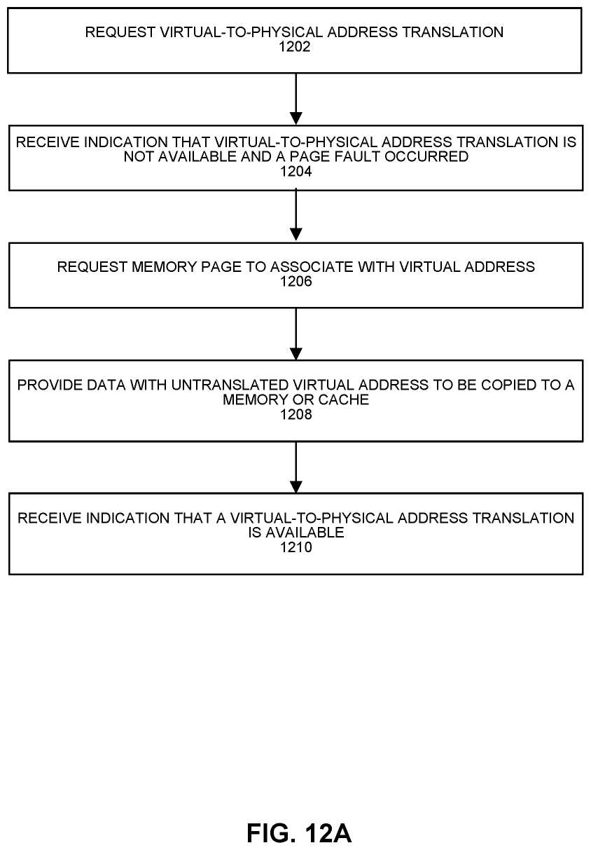

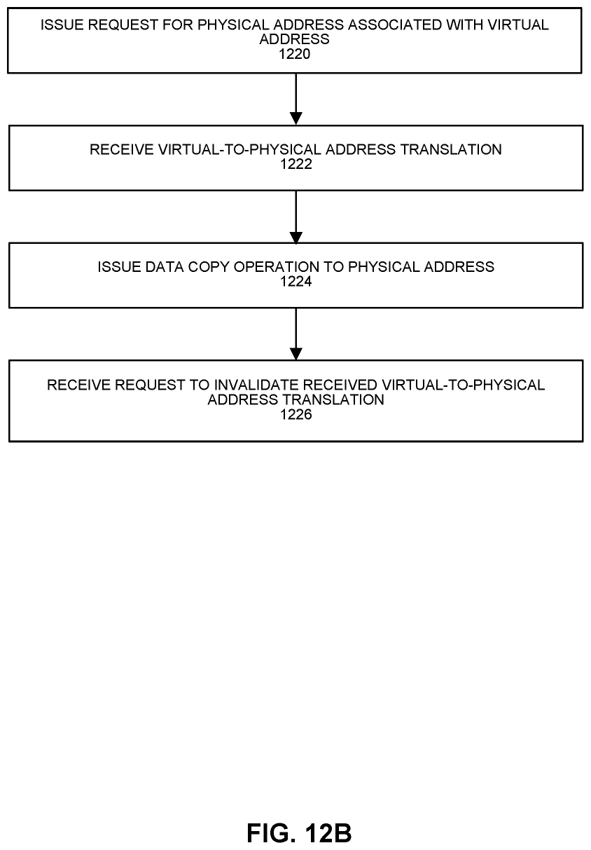

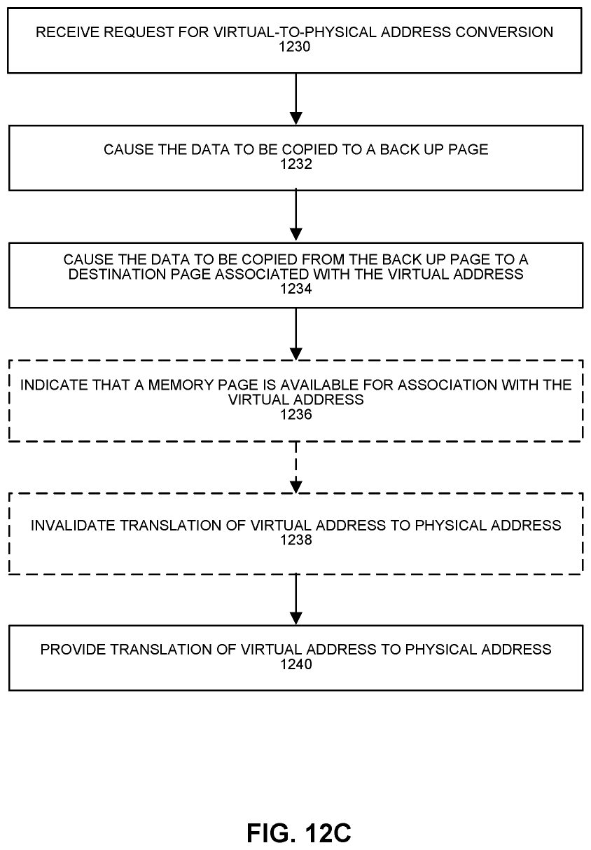

FIG. 12A depicts an example process of a device copying data to a memory device. At 1202, the device can issue a request for a physical address translation of a virtual address. At 1204, the device can receive an indication that a virtual-to-physical address translation is not available, and a page fault has occurred. At 1206, the device can request a memory page to associate with the virtual address. At 1208, the device can provide data with an untranslated virtual address and request that the data be copied to a destination memory or cache. In some examples, an IOMMU can cause the data to be stored in a backup memory page and, after a translation of the virtual address to a destination memory page is available, copy the data to a destination memory page. In some cases, use of the backup memory page can be based on the device determining and indicating that packet dropping is likely based on a fullness of a packet buffer. At 1210, the device can receive an indication from the IOMMU that a virtual to physical address translation is available.

FIG. 12B depicts an example process of a device copying data to a memory device. At 1220, the device can issue a request for a physical address translation of a virtual address. At 1222, the device can receive a virtual-to-physical address translation. The physical address in the virtual-to-physical address translation can be associated with a backup page and not a destination page. However, in some cases, the backup page can be set as the destination page in the virtual-to-physical address translation. At 1224, the device can issue a data copy operation request with a physical address. At 1226, the device can receive an indication to invalidate the received virtual-to-physical address translation. For example, the indication to invalidate the received virtual-to-physical address translation can occur after an IOMMU determines and associates a destination memory page with the virtual address so that the physical address provided for the backup memory page is not the correct physical address.

FIG. 12C depicts an example process that can be performed by an IOMMU. At 1230, the IOMMU can receive a request to perform a virtual-to-physical address translation and determine that the virtual-to-physical address translation is not available or is invalid. At 1232, the IOMMU can cause the device to copy data to a backup page. For example, in response to receipt of a request to copy data with an untranslated virtual address, the IOMMU can copy the data to the backup page. For example, the IOMMU can provide the physical address of the backup page to the device to copy data to that physical address of the backup page. At 1234, after determination of a destination page to receive the data from the device, the IOMMU can cause the data to be copied to the destination page. At 1236, in a case where the IOMMU received an untranslated virtual address, the IOMMU can indicate to the device that a memory page is associated with the virtual address, such as an indication of PRS completion. At 1238, in a case where the IOMMU provided the physical address of the backup page to the device to copy data to that physical address of the backup page, the IOMMU can indicate that the translation of the virtual address to the physical address is to be invalidated. At 1240, the IOMMU can indicate address completion and indicate the virtual-to-physical address translation for the virtual address that was subject to the address translation request in 1230.

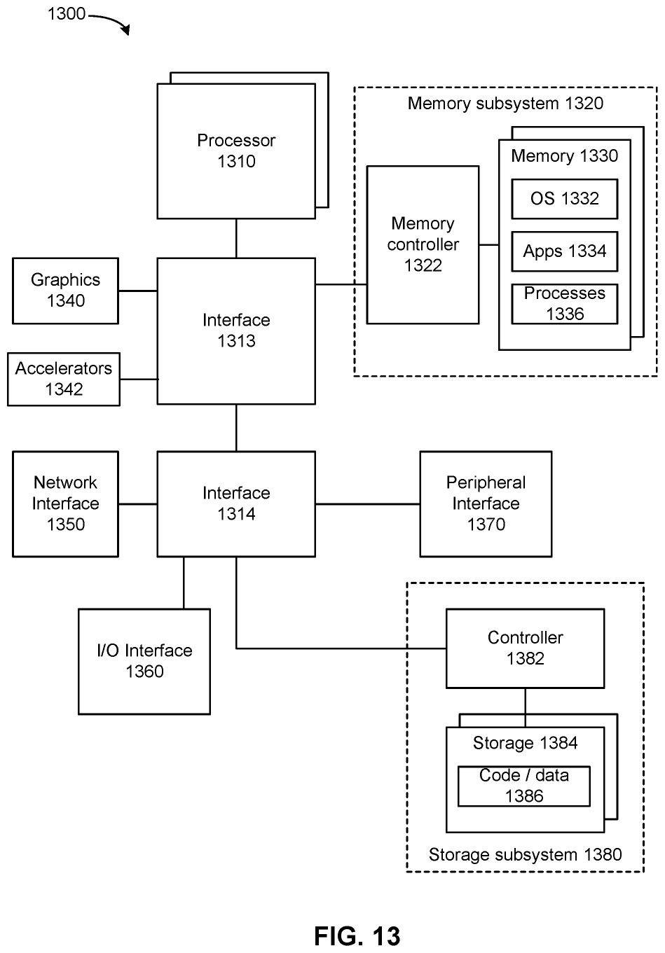

FIG. 13 depicts an example computing system. Components of system 1300 (e.g., processor 1310, network interface 1350, and so forth) to provide a backup page for a data copy in the event of a failure to translate a virtual address to a physical memory address and copy the data from the backup page to the destination page after a virtual-to-physical address translation is available, as described herein. System 1300 includes processor 1310, which provides processing, operation management, and execution of instructions for system 1300. Processor 1310 can include any type of microprocessor, central processing unit (CPU), graphics processing unit (GPU), processing core, or other processing hardware to provide processing for system 1300, or a combination of processors. Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1300 includes interface 1312 coupled to processor 1310, which can represent a higher speed interface or a high throughput interface for system components that needs higher bandwidth connections, such as memory subsystem 1320 or graphics interface components 1340, or accelerators 1342. Interface 1312 represents an interface circuit, which can be a standalone component or integrated onto a processor die. Where present, graphics interface 1340 interfaces to graphics components for providing a visual display to a user of system 1300. In one example, graphics interface 1340 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1340 generates a display based on data stored in memory 1330 or based on operations executed by processor 1310 or both. In one example, graphics interface 1340 generates a display based on data stored in memory 1330 or based on operations executed by processor 1310 or both.

Accelerators 1342 can be a fixed function or programmable offload engine that can be accessed or used by a processor 1310. For example, an accelerator among accelerators 1342 can provide compression (DC) capability, cryptography services such as public key encryption (PKE), cipher, hash/authentication capabilities, decryption, or other capabilities or services. In some embodiments, in addition or alternatively, an accelerator among accelerators 1342 provides field select controller capabilities as described herein. In some cases, accelerators 1342 can be integrated into a CPU socket (e.g., a connector to a motherboard or circuit board that includes a CPU and provides an electrical interface with the CPU). For example, accelerators 1342 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1342 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1320 represents the main memory of system 1300 and provides storage for code to be executed by processor 1310, or data values to be used in executing a routine. Memory subsystem 1320 can include one or more memory devices 1330 such as read-only memory (ROM), flash memory, one or more varieties of random access memory (RAM) such as DRAM, or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one example, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310.

In some examples, OS 1332 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure processors 1310, accelerators 1342, and/or network interface 1350 or other devices to provide a backup page for a data copy in the event of a failure to translate a virtual address to a physical memory address and copy the data from the backup page to the destination page after a virtual-to-physical address translation is available, as described herein.

In some examples, a driver can enable or disable processors 1310, accelerators 1342, and/or network interface 1350 or other device to provide a backup page for a data copy in the event of a failure to translate a virtual address to a physical memory address and copy the data from the backup page to the destination page after a virtual-to-physical address translation is available. A driver can advertise capability of one or more devices to perform one or more aspects of providing a backup page for a data copy in the event of a failure to translate a virtual address to a physical memory address and copying the data from the backup page to the destination page after a virtual-to-physical address translation is available.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1300 includes interface 1314, which can be coupled to interface 1312. In one example, interface 1314 represents an interface circuit, which can include standalone components and integrated circuitry. In one example, multiple user interface components or peripheral components, or both, couple to interface 1314. Network interface 1350 provides system 1300 the ability to communicate with remote devices (e.g., servers or other computing devices) over one or more networks. Network interface 1350 can include an Ethernet adapter, wireless interconnection components, cellular network interconnection components, USB (universal serial bus), or other wired or wireless standards-based or proprietary interfaces. Network interface 1350 can transmit data to a device that is in the same data center or rack or a remote device, which can include sending data stored in memory.

Some examples of network interface 1350 are part of an Infrastructure Processing Unit (IPU) or data processing unit (DPU) or utilized by an xPU, XPU, IPU or DPU. An xPU or XPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1300 includes one or more input/output (I/O) interface(s) 1360. I/O interface 1360 can include one or more interface components through which a user interacts with system 1300 (e.g., audio, alphanumeric, tactile/touch, or other interfacing). Peripheral interface 1370 can include any hardware interface not specifically mentioned above. Peripherals refer generally to devices that connect dependently to system 1300. A dependent connection is one where system 1300 provides the software platform or hardware platform or both on which operation executes, and with which a user interacts.

In one example, system 1300 includes storage subsystem 1380 to store data in a nonvolatile manner. In one example, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, or optical based disks, or a combination. Storage 1384 holds code or instructions and data 1386 in a persistent state (e.g., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (e.g., the value or state of the data is indeterminate if power is interrupted to system 1300). In one example, storage subsystem 1380 includes controller 1382 to interface with storage 1384. In one example controller 1382 is a physical part of interface 1314 or processor 1310 or can include circuits or logic in both processor 1310 and interface 1314.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 1300. More specifically, power source typically interfaces to one or multiple power supplies in system 1300 to provide power to the components of system 1300. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1300 can be implemented using interconnected devices including processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes a method comprising: in connection with a data copy to a destination memory address: based on a page fault, providing the data to a backup page and after determination of a virtual-to-physical address translation, copying the data in the backup page to a destination page identified by a physical address of the virtual-to-physical address translation.

Example 2 includes one or more examples, wherein providing the data to a backup page uses a direct memory access (DMA) device.

Example 3 includes one or more examples, wherein providing data to a backup page is based on a page fault and a target buffer for the data being detected as at or above a threshold level of fullness.

Example 4 includes one or more examples, wherein the backup page is identified by an Input-Output Memory Management Unit (IOMMU) driver.

Example 5 includes one or more examples, wherein providing the data to a backup page comprises: receiving the physical address of the backup page from a device and copying data from the device to the backup page based on identification of the backup page.

Example 6 includes one or more examples, wherein providing the data to a backup page comprises: receiving an untranslated virtual address with a request to copy the data and causing the data to be copied to the backup page.

Example 7 includes one or more examples, and includes at least during identification of the destination page identified by the physical address and association of a virtual address with the destination page associated with the physical address, locking a page table entry from access by a device driver, wherein the page table entry is indicative of a virtual-to-physical address translation.

Example 8 includes one or more examples, wherein an Input-Output Memory Management Unit (IOMMU) performs the providing the data to a backup page and copying the data in the backup page to a destination page identified by the physical address.

Example 9 includes one or more examples, and includes a computer-readable medium comprising instructions stored thereon, that if executed by one or more processors, cause the one or more processors to: enable a device, in connection with a data copy to a destination memory address, to: copy data to a backup page based on a page fault and after determination of a virtual-to-physical address translation, copy the data from the backup page to a destination page identified by a physical address of the virtual-to-physical address translation.

Example 10 includes one or more examples, wherein the provide data to a backup page is based on a page fault and a target buffer for the data being detected as at or above a threshold level of fullness.

Example 11 includes one or more examples, wherein the backup page is identified by an Input-Output Memory Management Unit (IOMMU) driver.

Example 12 includes one or more examples, wherein the provide data to a backup page based on a page fault comprises: receive the physical address of the backup page from the device and copy data from the device to the backup page based on identification of the backup page.

Example 13 includes one or more examples, wherein the provide data to a backup page based on a page fault comprises: receive an untranslated virtual address with a request to copy the data and cause the data to be copied to the backup page.

Example 14 includes one or more examples, and includes instructions stored thereon, that if executed by one or more processors, cause the one or more processors to: at least during identification of the destination page identified by the physical address and association of a virtual address with the destination page identified by the physical address, lock a page table entry from access by a device driver, wherein the page table entry is indicative of a virtual-to-physical address translation.

Example 15 includes one or more examples, wherein an Input-Output Memory Management Unit (IOMMU) is to perform the copy data to a backup page based on a page fault and the copy the data from the backup page to a destination page identified by the physical address.

Example 16 includes one or more examples, and includes an apparatus comprising: at least one processor and circuitry, when operational, to: in connection with a request from a device to copy data to a destination memory address: based on a page fault, copy the data to a backup page and after determination of a virtual-to-physical address translation, copy the data from the backup page to a destination page identified by a physical address of the virtual-to-physical address translation.

Example 17 includes one or more examples, wherein the copy the data to a backup page is based on a page fault and an indication that a target buffer for the data is at or above a threshold level of fullness.

Example 18 includes one or more examples, wherein the copy the data to a backup page comprises: receive the physical address of the backup page from the device and copy data from the device to the backup page based on identification of the backup page.

Example 19 includes one or more examples, wherein the copy the data to a backup page comprises: receive an untranslated virtual address with a request to copy the data and cause the data to be copied to the backup page.

Example 20 includes one or more examples, comprising circuitry, when operational to: at least during identification of the destination page associated with the physical address and association of a virtual address with the destination page identified by the physical address, lock a page table entry from access by a device driver, wherein the page table entry is indicative of a virtual-to-physical address translation.

Example 21 includes one or more examples, comprising: a server, wherein the server comprises the at least one processor and the circuitry and comprises at least one memory device that comprises the backup page and the destination page.

What is claimed is:

1. A method comprising:
in connection with a data copy to a destination memory address:
based on a page fault, providing the data to a backup page and
after determination of a virtual-to-physical address translation, copying the data in the backup page to a destination page identified by a physical address of the virtual-to-physical address translation.

2. The method of claim 1, wherein providing the data to a backup page uses a direct memory access (DMA) device.

3. The method of claim 1, wherein providing data to a backup page is based on a page fault and a target buffer for the data being detected as at or above a threshold level of fullness.

4. The method of claim 1, wherein the backup page is identified by an Input-Output Memory Management Unit (IOMMU) driver.

5. The method of claim 1, wherein providing the data to a backup page comprises:
receiving the physical address of the backup page from a device and
copying data from the device to the backup page based on identification of the backup page.

6. The method of claim 1, wherein providing the data to a backup page comprises:
receiving an untranslated virtual address with a request to copy the data and
causing the data to be copied to the backup page.

7. The method of claim 1, comprising:
at least during identification of the destination page identified by the physical address and association of a virtual address with the destination page associated with the physical address, locking a page table entry from access by a device driver, wherein the page table entry is indicative of a virtual-to-physical address translation.

8. The method of claim 1, wherein an Input-Output Memory Management Unit (IOMMU) performs the providing the data to a backup page and copying the data in the backup page to a destination page identified by the physical address.

9. A computer-readable medium comprising instructions stored thereon, that if executed by one or more processors, cause the one or more processors to:
enable a device, in connection with a data copy to a destination memory address, to:
copy data to a backup page based on a page fault and
after determination of a virtual-to-physical address translation, copy the data from the backup page to a destination page identified by a physical address of the virtual-to-physical address translation.

10. The computer-readable medium of claim 9, wherein the provide data to a backup page is based on a page fault and a target buffer for the data being detected as at or above a threshold level of fullness.

11. The computer-readable medium of claim 9, wherein the backup page is identified by an Input-Output Memory Management Unit (IOMMU) driver.

12. The computer-readable medium of claim 9, wherein the provide data to a backup page based on a page fault comprises:
receive the physical address of the backup page from the device and
copy data from the device to the backup page based on identification of the backup page.

13. The computer-readable medium of claim 9, wherein the provide data to a backup page based on a page fault comprises:
receive an untranslated virtual address with a request to copy the data and
cause the data to be copied to the backup page.

14. The computer-readable medium of claim 9, comprising instructions stored thereon, that if executed by one or more processors, cause the one or more processors to:
at least during identification of the destination page identified by the physical address and association of a virtual address with the destination page identified by the physical address, lock a page table entry from access by a device driver, wherein the page table entry is indicative of a virtual-to-physical address translation.

15. The computer-readable medium of claim 9, wherein an Input-Output Memory Management Unit (IOMMU) is to perform the copy data to a backup page based on a page fault and the copy the data from the backup page to a destination page identified by the physical address.

16. An apparatus comprising:
at least one processor and
circuitry, when operational, to:
in connection with a request from a device to copy data to a destination memory address:
based on a page fault, copy the data to a backup page and
after determination of a virtual-to-physical address translation, copy the data from the backup page to a destination page identified by a physical address of the virtual-to-physical address translation.

17. The apparatus of claim 16, wherein the copy the data to a backup page is based on a page fault and an indication that a target buffer for the data is at or above a threshold level of fullness.

18. The apparatus of claim 16, wherein the copy the data to a backup page comprises:
receive the physical address of the backup page from the device and
copy data from the device to the backup page based on identification of the backup page.

19. The apparatus of claim 16, wherein the copy the data to a backup page comprises:
receive an untranslated virtual address with a request to copy the data and
cause the data to be copied to the backup page.

20. The apparatus of claim 16, comprising circuitry, when operational to:
at least during identification of the destination page associated with the physical address and association of a virtual address with the destination page identified by the physical address, lock a page table entry from access by a device driver, wherein the page table entry is indicative of a virtual-to-physical address translation.

21. The apparatus of claim 16, comprising: a server, wherein the server comprises the at least one processor and the circuitry and comprises at least one memory device that comprises the backup page and the destination page.
